(19) United States
(12) Patent Application Publication
(10) Pub. No.: US 2025/0128982 A1
(43) Pub. Date: Apr. 24, 2025

(54) PHOSPHO-ALUMINO-SILICATE ERBIUM DOPED FIBER FOR EXTENDED L-BAND AMPLIFICATION

(71) Applicants: Huawei Technologies Canada Co., Ltd., Kanata (CA); Université Laval, Québec (CA)

(72) Inventors: Saber Jalilpiran, Québec City (CA); Jacques Lefebvre, Québec (CA); Nicolas Grégoire, Pont-Rouge (CA); Younès Messaddeq, Québec City (CA); Sophie Larochelle, Québec City (CA); Lixian Wang, Québec City (CA)

(73) Assignees: Huawei Technologies Canada Co., Ltd., Kanata (CA); Université Laval, Québec (CA)

(21) Appl. No.: 18/908,975

(22) Filed: Oct. 8, 2024

Related U.S. Application Data
(60) Provisional application No. 63/592,800, filed on Oct. 24, 2023.

(51) Int. Cl. C03C 13/04

(52) U.S. Cl. CPC C03C 13/045

(57) ABSTRACT

Fiber amplifiers for extending their gain bandwidth through an optimization of the host matrix using phosphorus/aluminum (P/Al) as glass modifier are provided. In one aspect, an optical glass fiber comprising an Erbium doped silicate is provided, where the optical glass fiber comprises P₂O₅ of greater than 6 mol %; and Al₂O₃ of between 1.5 and 6 mol %, where a molar percent ratio of the P₂O₅ and the Al₂O₃ is between 2 and 4. Further, in some cases, use of yttrium as an alternative co-dopant to ytterbium may be used.

### FIELD OF THE DISCLOSURE

The present disclosure relates to Erbium-doped fiber amplifiers (EDFAs), and in particular relates to EDFAs with enhanced capabilities in the long wavelength band.

### BACKGROUND

The background description includes information that may be useful in understanding the present inventive subject matter. It is not an admission that any of the information provided herein is prior art or applicant admitted prior art, or relevant to the presently claimed inventive subject matter, or that any publication specifically or implicitly referenced is prior art or applicant admitted prior art.

EDFAs integrated into optical fiber links have become ubiquitous in modern telecommunication systems, such as submarine systems and terrestrial backbone networks, to achieve long-distance and high-speed data transmission. Nonetheless, with the escalating demand for faster and more reliable data transmission, there is an urgent need to enhance the bandwidth and capacity of communication systems. The current limitations of EDFAs, including power conversion efficiency (PCE) and spectral coverage, thus pose challenges to be addressed to fully exploit the available low-loss transmission window of current optical fibers.

To this end, a commercially viable approach is to enhance the capabilities of EDFAs in the long wavelength band (L-band) by extending the upper wavelength limit (L⁺-band). Consequently, important research efforts have recently been devoted to explore various techniques to improve the performance of L-band EDFAs, including the use of novel dopants, co-dopants, and glass matrix, as well as optimizing the amplifier design and configuration.

Silica fibers doped with Erbium ions exhibit broad absorption and emission spectra that can be slightly tuned through modification of the glass. However, operating EDFA in the extended L-band (L⁺-band) region, located at the long wavelength limit of the emission spectrum, presents significant challenges. Firstly, the absorption and emission cross-sections in this region are considerably lower than in the C-band wavelengths, typically more than 20 times lower. Secondly, signal Excited State Absorption (ESA) leads to a sharp drop in the L-band gain at wavelengths longer than 1600 nm.

### SUMMARY

According to at least a first aspect of the present disclosure, there is provided an optical glass fiber comprising an Erbium doped silicate. In the first aspect, the optical glass fiber comprises P₂O₅ of greater than 6 mol %; and Al₂O₃ of between 1.5 and 6 mol %. Also in the first aspect, a molar percent ratio of the P₂O₅ and the Al₂O₃ is between 2 and 4.

In a first implementation of the first aspect, the optical glass fiber further comprises Y₂O₃ between 0 and 1.1 mol %.

In a second implementation of the first aspect, the optical glass fiber has an Erbium concentration of between 1.2×10²⁵ per m³ and 2.6×10²⁵ per m³.

In a third implementation of the first aspect, the optical glass fiber may comprise Yttrium, wherein an Erbium concentration in the Erbium doped silicate may be at or below 1.2×10²⁵ m⁻³.

In a fourth implementation of the first aspect, the optical glass fiber may have the molar percent ratio of the P₂O₅ and the Al₂O₃ of about 2.5, an Erbium concentration of about 1.2×10²⁵/m³, and with about 0.34 mol % of Yttrium.

In a fourth implementation of the first aspect, the optical glass fiber may further comprise GeO₂ of between 0 and 6.1 mol %.

In a second aspect, there is provided the use of the optical glass fiber of the first aspect in a Long Wavelength band amplifier.

In a second implementation of the second aspect the optical glass fiber may be capable of amplification up to a wavelength of 1626 nm.

In a third aspect an optical glass fiber comprising an Erbium doped silicate may be provided. In the third aspect, the optical glass fiber comprises P₂O₅ of greater than 6 mol %; and Al₂O₃ of between 1.5 and 6 mol %, wherein a molar percent ratio of the P₂O₅ and the Al₂O₃ is between 1.1 and 5.5.

In a first implementation of the third aspect, the optical glass may further comprise Y₂O₃ of between 0 and 1.1 mol %.

In a second implementation of the third aspect, the optical glass fiber may comprise an Erbium concentration in the Erbium doped silicate between 1.2×10²⁵ per m³ and 2.6×10²⁵ per m³.

In a third implementation of the third aspect the optical glass fiber may comprise Yttrium, wherein an Erbium concentration in the Erbium doped silicate may be at or below 1.2×10²⁵ m⁻³.

In a fourth implementation of the third aspect the optical glass fiber may have the molar percent ratio of the P₂O₅ and the Al₂O₃ of about 2.5, an Erbium concentration of about 1.2×10²⁵/m³, and with about 0.34 mol % of Yttrium as a de-clustering agent.

In a fifth implementation of the third aspect. the optical glass fiber may further comprise GeO₂ of between 0 and 6.1 mol %.

### BRIEF DESCRIPTION OF THE DRAWINGS

The present disclosure will be better understood having regard to the drawings in which:

FIG. 1 is a graph showing phosphorous to aluminum ratio profiles for preform cores scaled to the dimension of the corresponding drawn fiber core for six erbium doped fiber (EDF) samples.

FIG. 2 is a graph showing measured refractive index profiles for six EDFs.

FIG. 3 is a plot showing enlarged scanning electron microscopy micrographs of cross-sections of EDFs.

FIG. 4 is a graph showing broadband spectral loss of an EDF from 650 nm to 1750 nm.

FIG. 5 is a graph showing a normalized spectra for an absorption coefficient of EDFs with various P/Al ratios.

FIG. 6 is a graph showing normalized spectra for net gain coefficient of EDFs with various P/Al ratios.

FIG. 7 is a graph showing an absolute value of a net gain coefficient and the signal excited state absorption as a function of wavelength for six EDFs.

FIG. 8 is a graph showing wavelengths at which the net gain coefficient equals the signal excited state absorption as a function of Al₂O₃ (Mol. %).

FIG. 9 is a graph showing simulated gain curves for six EDFs obtained by selecting values of N₂ and L to minimize the gain ripple.

FIG. 10 is a graph showing Er³⁺ pair percentage as a function of average Er³⁺ concentration in the preform core.

FIG. 11 is a block diagram showing an experimental setup that can be used with the embodiments of the present disclosure.

FIG. 12 is a graph showing gain and noise figure spectrum comparison of six EDFs using a 1.3 dBm input signal optimized to obtain a lowest gain ripple.

FIG. 13 is a graph showing normalized gain shape comparison of EDFs.

FIG. 14 is a graph showing the normalized gain at a wavelength of 1626 nm versus a P/Al ratio.

### DETAILED DESCRIPTION OF THE DRAWINGS

The present disclosure is directed to improving amplification efficiency at longer wavelengths. While there have been attempts to improve the amplification efficiency at longer wavelengths by heavily doping the fibers with Erbium (Er) ions, as for example described by M. E. Likhachev et al., “Effect of the AlPO4 join on the pump-to-signal conversion efficiency in heavily Er-doped fibers,” Opt. Lett., vol. 34, no. 21, pp. 3355-3357 October 2009, and M. Kakui et al., “Long-wavelength-band optical amplifiers employing silica-based erbium doped fibers designed for wavelength division multiplexing systems and networks,” IEEE Trans. Electron., vol. 83, pp. 799-815, June 2000, the contents of which are incorporated herein by reference, there is a limit to the solubility of Er ions in silica glasses that leads to clustering and quenching of the active ions. This may result in a degradation of the Power Conversion Efficiency (PCE), as for example described in L. V Kotov et al., “High-performance cladding-pumped erbium-doped fibre laser and amplifier,” Quantum Electron., vol. 42, no. 5, pp. 432-436, May. 2012, the contents of which are incorporated herein by reference.

Addressing clustering and quenching may thus be used to enhance the efficiency of L⁺-band EDFA. One possible strategy is investigating how the various glass modifiers and co-dopants impact the solubility and performance. For example, it has been shown in K. Bourhis et al., “Influence of P₂O₅ and Al₂O₃ content on the structure of erbium-doped borosilicate glasses and on their physical, thermal, optical and luminescence properties,” Mater. Res. Bull., vol. 63, pp. 41-50, March 2015, the contents of which are incorporated herein by reference, that incorporating of specific amounts of phosphorus (P) and/or aluminum (Al) into the silica core helps to mitigate the clustering of Er ions.

In addition, adding alkaline earth metal oxides (such as BaO, CaO, SrO, and MgO) promotes the depolymerization of the glass network and the creation of non-bridging oxygen (NBO) groups, which can increase the Er ions solubility, as for example described in M. Kuwik et al., “Influence of oxide glass modifiers on the structural and spectroscopic properties of phosphate glasses for visible and near-infrared photonic applications,” Materials, vol. 13, no. 21, p. 4746 October 2020, the contents of which are incorporated herein by reference.

In the latter case, the glass composition is delicate because phase separation can cause high scattering losses if the specific fabrication parameters of the preform and fiber are not maintained, as described in V. Fuertes et al., “Engineering nanoparticle features to tune Rayleigh scattering in nanoparticles doped optical fibers,” Sci. Rep., vol. 11, no. 9116, pp. 1-12, April 2021, and S. Jalilpiran et al., “Baria-Silica Erbium-Doped Fibers for Extended L-band Amplification,” J. Lightwave Technol., vol. 41, no. 14, pp. 4806-4814 July 2023, the contents of which are incorporated herein by reference.

Further, it was demonstrated in S. Jalilpiran et al., “Baria-Silica Erbium-Doped Fibers for Extended L-band Amplification,” J. Lightwave Technol., vol. 41, no. 14, pp. 4806-4814 July 2023, the contents of which are incorporated herein by reference, that incorporating BaO as a co dopant in the silica host can effectively reduce background loss and enhance the solubility of erbium ions leading to amplification beyond 1620 nm. However, increasing the amount of BaO did not significantly change the absorption and emission spectra at longer waveband, thereby limiting its effectiveness in further enhancing L⁺-band amplification.

Silica-based glasses, whether or not doped with Phosphorus (P) and/or aluminum (Al), offer many practical advantages, including easy fiber fabrication, compatibility with current transmission fiber, and excellent mechanical strength, that make them good host materials for fiber amplifiers. For L-band amplification, it was demonstrated in Z. Zhai et al., “Extending L-Band Gain to 1625 nm Using Er3+:Yb3+ Co-Doped Silica Fibre Pumped by 1480 nm Laser Diodes,” 2022, doi: 10.5258/SOTON/D2202, and in Z. Zhai et al., “1480 nm Diode-Pumped Er³⁺:Yb³⁺ Co-Doped Phospho-Alumino-Silicate Fiber for Extending the L-Band Gain Up to 1625 nm,” J. Lightwave Technol., vol. 41, no. 11, pp. 3432-3437 June 2023, [Zhai-2] the contents of both of which are incorporated herein by reference, that P/Al silicate is a promising host since the addition of P₂O₅ and/or Al₂O₃ to the silica-based core composition was observed to partially modify the absorption and emission properties of Er³⁺. In Z. Zhai et al, “Temperature-Dependent Study on L-Band EDFA Characteristics Pumped at 980 nm and 1480 nm in Phosphorus and Aluminum-Rich Erbium-Doped Silica Fibers,” J. Lightw. Technol., vol. 40, no. 14, pp. 4819-4824 July 2022, and M. E. Likhachev et al., “Erbium-doped aluminophosphosilicate optical fibres,” Quantum. Elec., vol. 40, no. 7, pp. 633-638, 2010, the contents of which are incorporated herein by reference, the effects of adding P₂O₅ were compared to those of Al₂O₃.

Zhai-2, supra, considered Er/Ytterbium (Yb) co-doped phosphor-alumino-silicate fibers to achieve extended L-band amplification with 1480 nm pumping. It concluded that a higher Yb-to-Er concentration ratio results in a redshift of the ESA onset, which improves the amplification bandwidth. However, Zhai-2 did not consider the combined use of both dopants at their optimum content.

The present disclosure is directed to optimizing the P₂O₅ and Al₂O₃ content of the silicate host to further extend the L-band gain. In particular, a selected ratio of P₂O₅ and Al₂O₃ is used to improve the amplification properties in the L₊-band. Finding the improved composition is challenging since P₂O₅ doping can result in a dip in the refractive index profile, whereas a high concentration of Al₂O₃ can cause a “star-like” core with increased scattering loss.

The concurrent doping of these elements leads to the formation of AlPO₄-like units that exhibit distinctive characteristics compared to using only Al₂O₃ or P₂O₅. Therefore, careful consideration may need to be taken when incorporating these dopants to achieve desired outcomes.

Further, adding Yb, mixed with Al and/or P, to the silica fiber core serves as a de-clustering agent to prevent Er ion clustering, as for example described in Y. Chen et al., “Extending the L-band amplification to 1623 nm using Er/Yb/P co-doped phosphosilicate fiber,” Opt. Lett., vol. 46, no. 23, pp. 5834-5837 November 2021, and N. V. Kiritchenko et al., “Effect of ytterbium co-doping on erbium clustering in silica-doped glass,” Laser Phys., vol. 25, no. 2, 25102, January 2015, the contents of both of which are incorporated herein by reference. However, Yb is not compatible with the direct pumping of Er ions with 980 nm, which is well-known for achieving cost-effective, low-noise, and temperature-stable amplifiers. Therefore, in accordance with some embodiments of the present disclosure, Yttrium (Y) is used instead of Yb as a de-clustering agent to improve the Er³⁺ solubility. The use of Y is compatible with 980 nm pumping.

Thus, embodiments of the present disclosure are focused on two aspects: firstly, to modify the glass matrix by optimizing the P to Al (P/Al) ratio with the aim to extend the gain bandwidth of the L band to wavelengths beyond 1625 nm and, secondly, to co-dope the fibers with Y to reduce clustering while allowing 980 nm pumping.

### Fiber Fabrication and Properties

In the embodiments of the present disclosure, various fabricated fiber samples are presented, focusing on material composition, P/Al ratios, and microstructure characterization of the core using scanning electron microscopy (SEM). The main fiber parameters are also listed.

In order to demonstrate the embodiments of the present disclosure, six fibers were fabricated, denoted as EDF1 to EDF6. These fibers were arranged in ascending order according to their molar ratio of P/Al contents, with EDF1 having the lowest P/Al content ratio of 1.1 and EDF6 having the highest of 5.5, of the fiber set. As provided below, the best performance was achieved in EDF3.

Each fiber was drawn from a preform fabricated using the modified chemical vapor deposition (MCVD) method combined with solution doping, during which P, Al, Y, and Er were infused into the silica matrix. In the MCVD a fused quartz tube was first coated with a porous SiO₂ soot at 1350° C. using a gas mixture of SiCl₄, oxygen, and helium. The tube was then transferred to a nitrogen purged holder where solution doping with H₃PO₄, AlCl₃·6H₂O, YCl₃·6H₂O, and ErCl₃·6H₂O was performed. The tube was subsequently re-mounted on the MCVD lathe for vitrification and tube collapse at a temperature above 2000° C. For preforms having germanium elements, a flow of GeCl₄ was supplied during vitrification. Optical fibers were drawn at ˜2100° C. after stretching and sleeving the fabricated preform necessary to adjust the final core/cladding dimensions.

The fiber parameters and material contents for each of EDF1 to EDF6 are detailed in Table 1 below.

TABLE 1
Parameters and Composition of Fabricated Fiber Samples

| Quantity | EDF1 | EDF2 | EDF3 | EDF4 | EDF5 | EDF6 |
|---|---|---|---|---|---|---|
| P₂O₅ (mol. %) | 6.3 ± 0.9 | 7.8 ± 0.6 | 9.1 ± 0.8 | 7.8 ± 0.4 | 7.2 ± 0.7 | 8.3 ± 0.9 |
| Al₂O₃ (mol. %) | 5.8 ± 0.6 | 4.8 ± 0.2 | 3.7 ± 0.2 | 2.7 ± 0.2 | 2.0 ± 0.1 | 1.5 ± 0.1 |
| GeO₂ (mol. %) | 1.2 ± 0.4 | 3.3 ± 0.3 | 4.7 ± 1.4 | — | — | — |
| Y₂O₃ (mol. %) | 0.9 ± 0.2 | 0.67 ± 0.1 | 0.34 ± 0.1 | 0.71 ± 0.1 | 0.74 ± 0.1 | 0.54 ± 0.1 |
| Er₂O₃ (mol. %) | 0.07 ± 0.02 | 0.05 ± 0.01 | 0.03 ± 0.01 | 0.06 ± 0.01 | 0.06 ± 0.01 | 0.05 ± 0.01 |
| P/Al | 1.1 ± 0.1 | 1.6 ± 0.2 | 2.5 ± 0.2 | 2.9 ± 0.2 | 3.6 ± 0.3 | 5.5 ± 0.4 |
| Er Conc. (×10²⁵ | 2.6 | 2.1 | 1.2 | 2.3 | 2.5 | 2.0 |
| m⁻³) | | | | | | |
| D (μm) | 6.21 | 5.61 | 5.76 | 5.99 | 6.38 | 5.50 |
| NA | 0.16 | 0.16 | 0.18 | 0.15 | 0.15 | 0.17 |
| Δn | 0.009 | 0.009 | 0.012 | 0.008 | 0.008 | 0.010 |
| Cut-off λ (μm) | 1.30 | 1.20 | 1.39 | 1.21 | 1.28 | 1.21 |
| MFD @1590 (μm) | 7.7 | 7.3 | 6.8 | 7.7 | 7.9 | 7.1 |
| Γ @1590 μm | 0.70 | 0.65 | 0.74 | 0.65 | 0.70 | 0.66 |

Analysis of the preforms using an electron probe micro-analyzer (EPMA) revealed averaged P/Al ratios of 1.1, 1.6, 2.5, 2.9, 3.6, and 5.5 for EDF1 to EDF6, respectively.

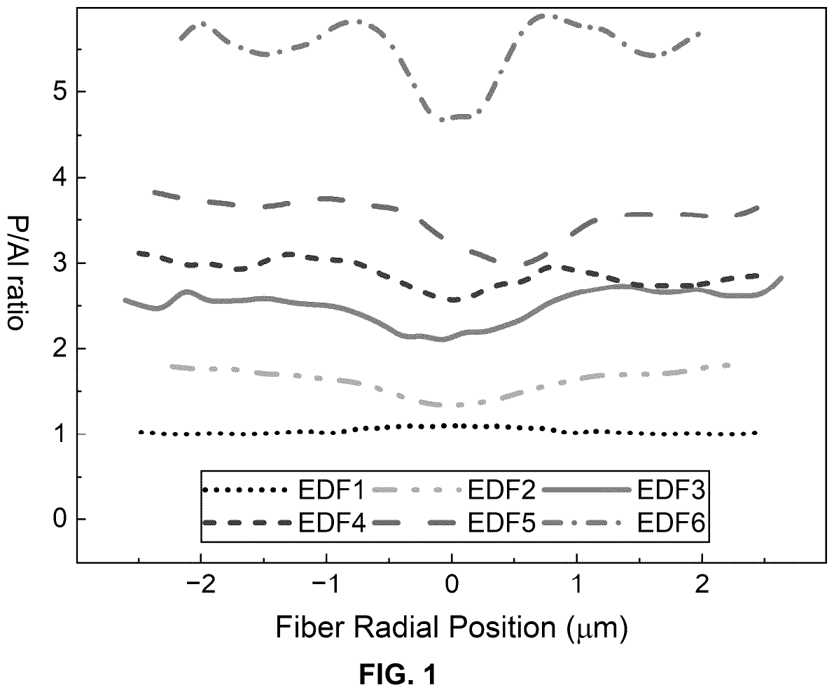

Reference is now made to FIG. 1, which shows the P/Al ratio profiles in the preform core, scaled to the core dimensions of the corresponding drawn fiber, for all samples. Some variations of ±15% in the P/Al ratios are observed across the core but, nonetheless, the fiber samples are still distinct enough to allow for an evaluation of the impact of the material composition on the fiber performance.

In particular, as seen in FIG. 1, each of EDF1, EDF2, EDF3, EDF4, EDF5 and EDF6 are labeled with a different line format. Further from FIG. 1, the phosphorus to aluminum ratio, when compared with the fibre radial position, shows that the samples are distinct from each other.

Due to the refractive indices of P₂O₅, Al₂O₃, and Y₂O₃ being higher than that of SiO₂, the incorporation of these elements creates a step-index profile that is sufficient to create a single-mode waveguide in EDF4, EDF5, and EDF6. In the other samples (EDF1, EDF2, and EDF3), germanium was added to increase the refractive index and achieve a desired core/cladding refractive index difference (Δn), while maintaining the target P/Al ratio. Considering the Δn observed in the preform Refractive Index Profile (RIP) measurements and aiming for a cut-off wavelength below 1400 nm, the fiber core diameters were designed to facilitate single-mode propagation of L-band signals.

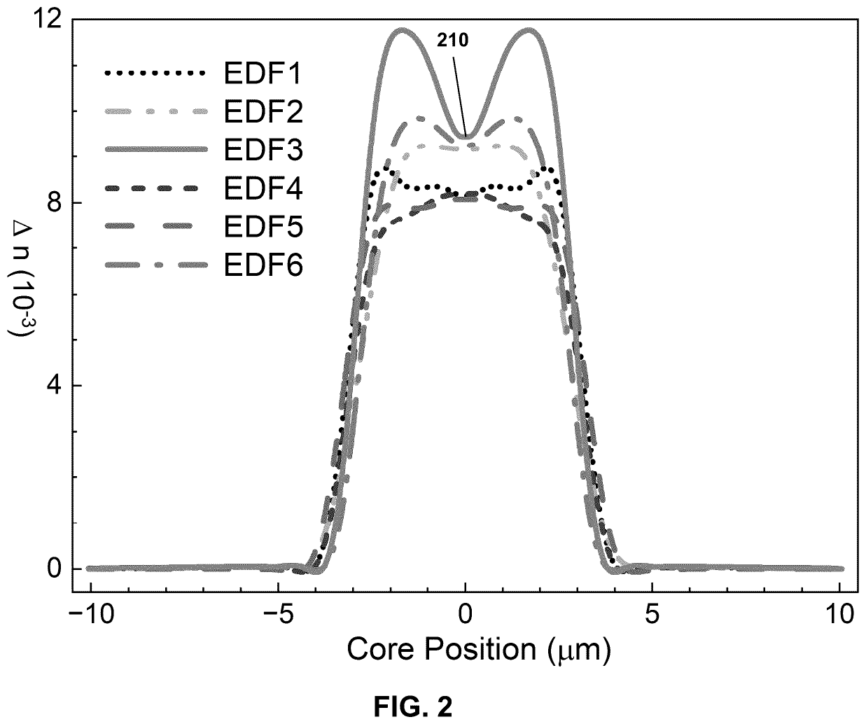

Referring to FIG. 2, RIP of the fibers were measured at 632.8 nm with an uncertainty of ±0.00005. Note that EDF3, which has the highest concentration of phosphorus (˜9.1 mol. %), displays an important central dip 210 of approximately 20% in its RIP. Conversely, the other fibers exhibit central dips of less than 7%. This aligns with the commonly observed trend that higher phosphorus concentrations may lead to an increase in the central dip, as for example described in P. Law et al., “Acoustic coefficients of P2O5-doped silica fiber: the strain-optic and strain-acoustic coefficients,” Opt. Mater. Express., vol. 2, no. 4, pp. 391-404, March 2012, and A. Dhar et al., “Fabrication of high aluminium containing rare-earth doped fiber without core-clad interface defects,” Opt. Commun., vol. 283, no. 11, pp. 2344-2349 June 2010, the contents of which are incorporated herein by reference.

In the embodiments of the present disclosure, one aim is to ensure that the phosphorus content remains below 9 mol. % to avoid a central dip exceeding 20% of the maximum refractive index value in the RIP.

The fiber parameters listed in Table 1 above include the core diameter (D), numerical aperture (NA), Δn, cut-off wavelength, overlap factor (Γ), and mode field diameter (MFD) of the EDFs. These parameters were estimated from the measured RIPs and erbium concentration profiles. The mode profiles were calculated from the RIP with COMSOL modeling software. The calculated overlap factors at 1590 nm fall within the range of 0.65 to 0.75.

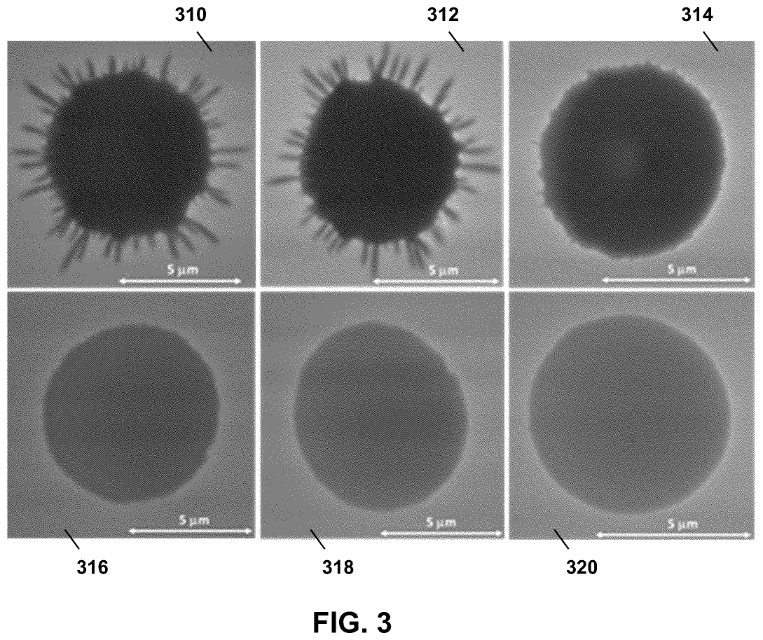

Referring to FIG. 3, this figure displays SEM micrographs of the cross-sectional view of the EDF cores. In particular, micrograph 310 is an enlarged cross-sectional view of EDF1. Micrograph 312 is an enlarged cross-sectional view of EDF2. Micrograph 314 is an enlarged cross-sectional view of EDF3. Micrograph 316 is an enlarged cross-sectional view of EDF4. Micrograph 318 is an enlarged cross-sectional view of EDF5. Micrograph 320 is an enlarged cross-sectional view of EDF6. Each of micrographs 310, 312, 314, 316, 318 and 320 allow for examination of the core-cladding interface.

From FIG. 3, increasing the amount of Al leads to a core structure having a “star-like” shape, resulting in increased background loss in the optical fiber. This can, in particular, be seen in micrographs 310 and 312.

The micrographs of FIG. 3 thus support the conclusions of studies by P. Law, supra and A. Dhar, supra, illustrating that decreasing the amount of Al leads to a smoother and better-defined core-clad interface.

Further, for testing, a reference fiber sample with Ytterbium (Yb) as a de-clustering agent was fabricated. The Yb—P/A-EDF sample had the same fiber parameters and material composition as EDF6, with the only difference being that Y was replaced with Yb.

### EDF Characterization

Using the fibers described above, a comprehensive optical characterization of the fiber samples was performed. This involved the measurement of background loss and in-band absorption and emission coefficients, as well as the calculation of the net gain coefficient when considering signal excited-state absorption.

To determine the percentage of ion pairs, non-saturable absorption was measured. The influence of P/Al ratios, de-clustering agents, and Er ion concentrations on these parameters are discussed below.

The characterization of the EDFs is thus provided, focusing on background loss, in-band absorption, emission, ESA spectra, net gain coefficient, and clustering ratio. The P/Al ratio and the use of Y as a de-clustering agent is discussed, including how they impact the parameters that define EDFA performance in the target L⁺-band.

As provided with regard to FIG. 2, the P content is deliberately maintained at approximately 8 mol. % to prevent the occurrence of an overly pronounced central dip 210.

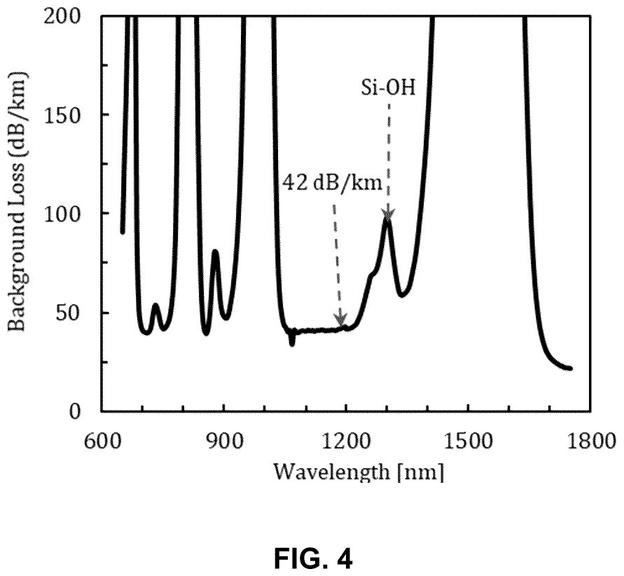

Reference is now made to FIG. 4, which illustrates the broadband loss spectrum of EDF3, obtained through a conventional cut-back method, covering the 650-1750 nm band. Besides the absorption peaks (>150 dB/km) only attributed to Er³⁺ transitions, the presence of a peak near 1300 nm indicates the existence of Si—OH bonds in the P/Al-silica glass. The smaller peaks observed at 730 and 875 nm are likely associated with trace rare earth contaminants (0.02-0.10 ppm), such as Nd³⁺, present in Erbium chloride hydrate.

A comparison of the broadband loss measurement results with those of the Ba-EDFs presented in S. Jalilpiran, supra, which were fabricated and measured using the same technique and setup and technique, confirms the absence of any unexpected absorption peaks associated with yttrium. Furthermore, the measured background loss in the 1200 nm spectral window, where Er³⁺ is inactive, for both EDF6 and Yb—P/Al-EDF, confirmed that replacing Y with Yb did not result in higher loss.

Table 2 below shows a measured loss, absorption, gain and Noise Figure (NF) of the EDF samples. As listed in Table 2, the measured background loss indicates that reducing the P/Al from 3.6 to 1.1 (from EDF5 to EDF1) results in higher background loss. This may be attributed to the formation of the “star-like” shape in the core structure, as illustrated in FIG. 3. Conversely, when the P/Al ratio is increased from 3.6 to 5.5 (from EDF5 to EDF6), there is an observed increase in background loss. Thus, in this embodiment, there appears to be an optimal ratio of approximately 3.6 for mitigating background loss.

TABLE 2
Measured Loss, Absorption, Gain and NF of the EDF Samples

| Quantity | EDF1 | EDF2 | EDF3 | EDF4 | EDF5 | EDF6 |
|---|---|---|---|---|---|---|
| Background loss @ 1200 nm | 102 | 53 | 42 | 30 | 28 | 46 |
| (dB/km) | | | | | | |
| Absorption coefficient (α) | 42.3 | 42.9 | 25.4 | 41.8 | 45.9 | 33.1 |
| @1536 nm (dB/m) | | | | | | |
| Net gain coefficient (g*) | 45.0 | 44.3 | 25.6 | 41.6 | 41.9 | 32.4 |
| @1536 nm (dB/m) | | | | | | |
| PIQ (%) | 9.2 | 6.4 | 2.8 | 7.4 | 8.1 | 6.1 |
| ζ (×10¹⁶ m⁻¹s⁻¹) | 6.1 | 5.5 | 2.7 | 5.9 | 5.4 | 3.6 |
| Gain @1626 nm (dB) | 7.3 | 11.2 | 15.0 | 13.6 | 13.1 | 13.3 |
| NF @1626 nm (dB) | 8.2 | 7.4 | 6.3 | 6.2 | 6.1 | 6.4 |
| Min. Gᵣᵢₚₚₗₑ (%) | 203 | 103 | 76 | 78 | 81 | 101 |

To determine the in-band absorption coefficient, α(λ) for the ⁴I_{15/2}→⁴I_{13/2} Er³⁺ transition, the cutback technique described in S. Jalilpiran, supra, was used over a wavelength range from 1500 nm to 1630 nm using a tunable laser source (TLS). To minimize any potential impact from re-emission effects, the input signal power was maintained below −30 dBm.

To ensure accurate measurements with minimal uncertainty, the procedure outlined in H. Feng et al., “Characterization of Giles Parameters for Extended L band Erbium-Doped Fibers,” J. Opt. Soc. Am. B., vol. 39, no. 7, pp. 1783-1791, the contents of which are incorporated herein by reference, was used. This resulted in a measurement uncertainty of less than 5%.

The measurement was conducted across four distinct wavelength bands: 1500-1521 nm, 1521-1550 nm, 1550-1580 nm, and 1580-1630 nm. For each band, cutback lengths that corresponded to the fiber exhibiting a loss of 30 to 35 dB were selected.

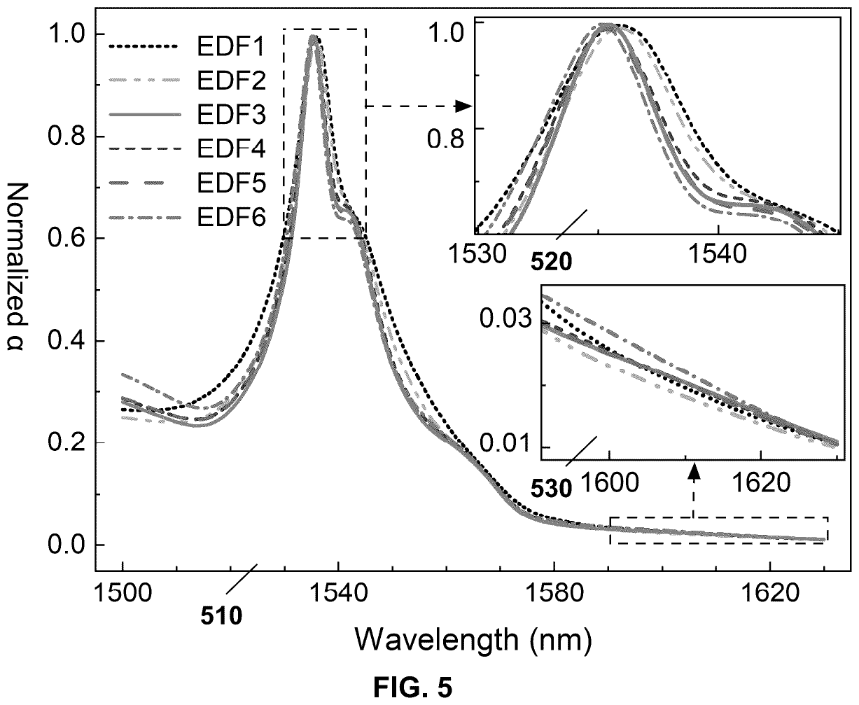

Referring to FIG. 5, plot 510 provides a comparison of the measured absorption coefficient spectra, which have been normalized to the peak intensity, with a zoomed-in view 520 of the peak and an additional zoomed-in view 530 of the longer wavelength part.

Table 2 above presents the measured peak absorption values for each fiber, with the peak absorption occurring at 1535.5±0.5 nm. The impact of P and Al contents on the spectral characteristics can be seen in FIG. 5. Notably, among the fibers, EDF3 exhibits the narrowest spectra within the C-band, with a slight flattening of the absorption coefficient spectra observed for wavelengths greater than 1590 nm. This flattening of α(λ) in EDF3 for λ>1590 nm is particularly pronounced when contrasted with the spectra of EDF1 and EDF6.

These two fibers represent the lowest and highest P/Al ratios, respectively, and the distinct disparity becomes more evident when observing the respective spectral profiles.

In addition to the absorption coefficient α(λ), the net gain coefficient g*(λ) may be used for assessing the behavior of the gain and evaluating the performance of an EDFA in the L-band. The g*(λ) represents the gain of a 1-meter-long erbium fiber under the assumption that it is fully inverted. It encompasses two transition processes: the emission coefficient g₂₁(λ), associated with the stimulated emission ⁴I_{13/2}→⁴I_{15/2} transition, and the signal excited state absorption (ESA) process. The ESA process is an undesired transition occurring at longer wavelengths (e.g., λ>1580 nm) as it involves absorption from the ⁴I_{13/2}→⁴I_{9/2} levels. The difference between g₂₁ and g* is defined as ESA(λ) in Equation (1) below:

$$E S A ( λ ) = {g}_{21} ( λ ) - {g}^{*} ( λ ) \qquad ( 1 )$$

To measure g*(λ), a first step is to determine the emission coefficient g₂₁(λ). To accomplish this, the measured α(λ) values within the wavelength range of 1500 nm to 1630 nm may be used, and the values may be incorporated into the McCumber relation described in M. Bolshtyansky et al., “Signal excited-state absorption in the L-band EDFA: Simulation and measurements,” J. Light. Technol., vol. 23, no. 9, pp. 2796-2799, the contents of which are incorporated herein by reference.

In a next step, the on-off gain measurements may be performed, as for example described in S. Jalilpiran, supra, and H. Feng, supra. For these measurements, a single-stage amplifier setup using short fiber lengths that corresponded to a 30-dB loss at peak absorption for each fiber was used. All sample measurements were conducted under identical conditions to ensure a precise comparison.

During the ON step, the EDF sample is pumped with a power of 400 mW at 978 nm, resulting in N₂>90%, where N₂ represents the effective Er³⁺ population on the excited state ⁴I_{13/2}.

For the final part of the analysis, a fitting procedure was used to extract N₂ and λ_{c}. The wavelength λ_{c} represents the one at which g₂₁ is equal to α in the McCumber equation. For this fit, it was assumed that g*(λ) is equal to g₂₁(λ) at the shorter wavelengths (λ<1580 nm) and the g*(λ) was calculated.

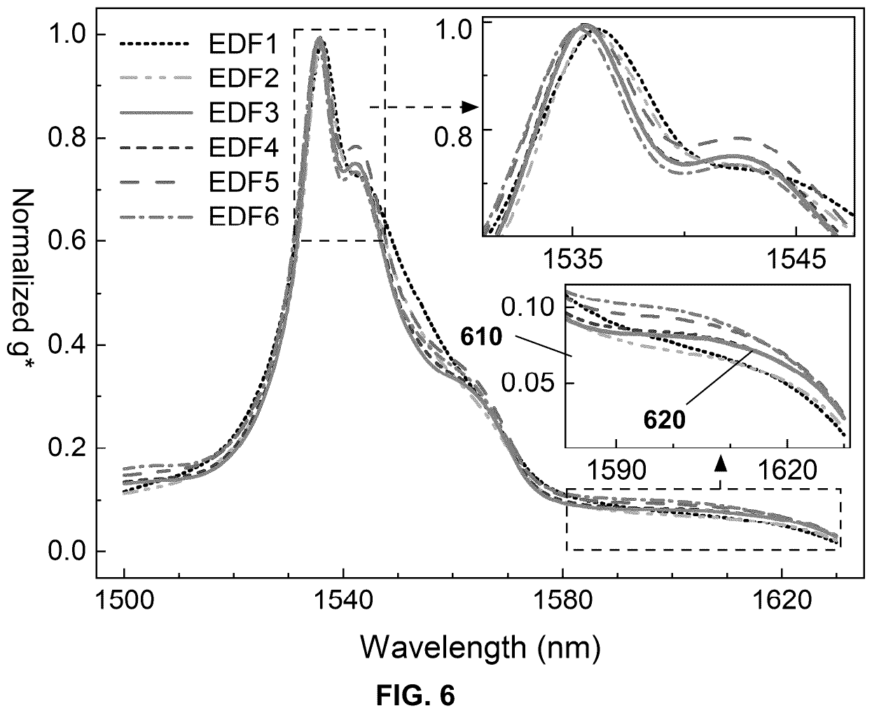

Reference is now made to FIG. 6, which displays the obtained normalized g* curves, while Table 2 presents the measured peak g* values for all fibers. Examining the inset 610 of FIG. 6 (for λ>1580 nm) reveals that a P/Al ratio near 2.5 (EDF3 620) produces the flattest curve in the L-band, which may be beneficial for amplification in this range. To be more precise, in FIG. 6 the decline in g* from 1580 to 1630 nm is as follows for EDF1 through EDF6: 9.5%, 7.7%, 6.7%, 7.2%, 8.0%, and 8.5%, respectively.

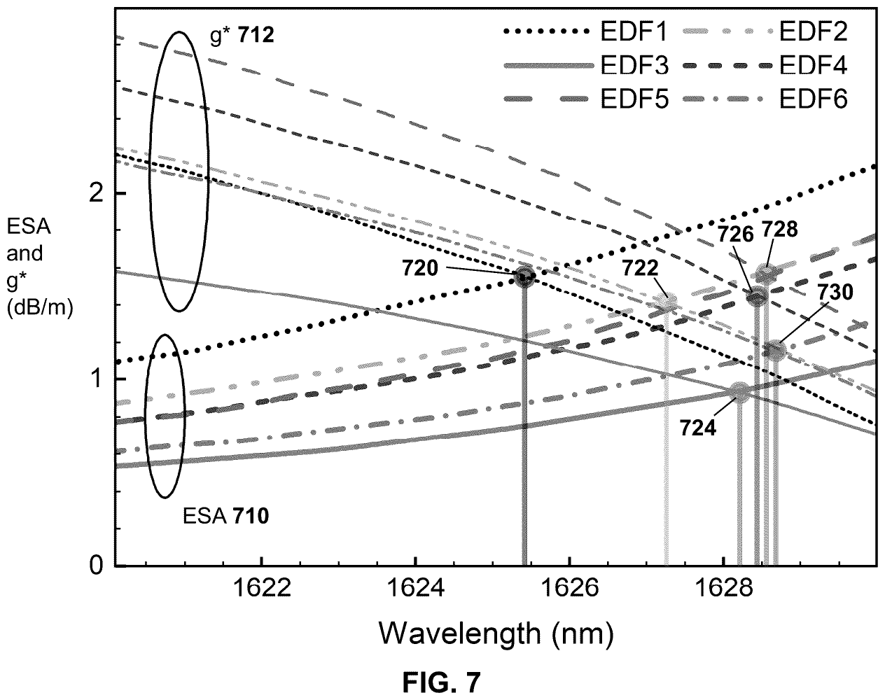

ESA is known to restrict amplification and increase the noise figure at the longer wavelengths of the L-band. As seen in FIG. 7, to estimate the ESA coefficient, equation (1) may be used, and the result plotted with lines 710, alongside the g*, shown with lines 712.

Among the samples, EDF3 exhibits the smallest ESA coefficient; however, it also has the lowest Er³⁺ concentration. To facilitate a fair comparison of ESA impact and mitigate the influence of the Er³⁺ concentration, the wavelengths (λ_{ESA}) at which ESA equals g* or half of g₂₁ were focused on. In FIG. 7, these specific wavelengths are shown as points 720, 722, 724, 726, 728 and 730, each connected to corresponding wavelengths by lines. It is evident that the ESA is red shifted from EDF1 to EDF3 (points 720, 722 and 724) and that further increasing the P/Al ratio results in only a slight additional red shift (points 726, 728, 730).

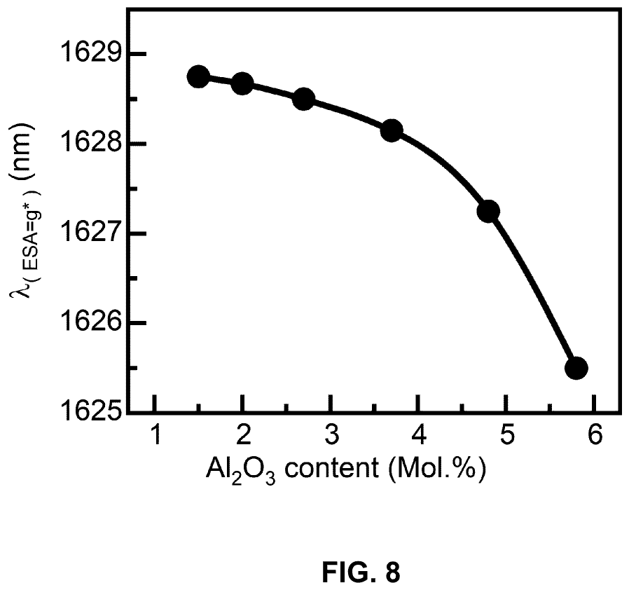

A careful analysis of the material composition in Table 1 and the corresponding experimental results reveal a trend with respect to the Al₂O₃ content. As shown in FIG. 8, the ESA wavelength (λ_{ESA}), at which g*=ESA, is presented as a function of Al₂O₃ content (Mol. %), from which it can be inferred that the presence of Al has an adverse effect on L-band amplification, i.e., the ESA is shifted towards the L-band.

To evaluate how absorption and emission spectra would impact the gain performance within the target wavelength range of 1575 to 1625 nm, equation (2) may be used:

$$G ( λ ) = L [ ( α ( λ ) + {g}^{*} ( λ ) ) {N}_{2} - α ( λ ) - l ( λ ) ] \qquad ( 2 )$$

where L is the EDF length, G is the amplifier gain, l is the background loss, and N₂ is the fractional population in level ⁴I_{13/2}. It is assumed that N₂ is constant along the EDF length (average value), and the impact of amplified spontaneous emission (ASE) have been neglected. Equation (2) enables examination of how the spectral dependence of the absorption and emission coefficients impact the overall performance of the EDFA and more specifically the gain ripple. In equation (2), the value of N₂ specifies the gain shape, while L determines actual gain. A minimum gain of 30 dB over the spectral band was targeted, and then the variables N₂ and L were varied to find an optimal gain shape, i.e., the one exhibiting the lowest gain ripple defined with equation (3).

$$gain ripple = \frac{{G}_{max} - {G}_{min}}{{G}_{min}} \qquad ( 3 )$$

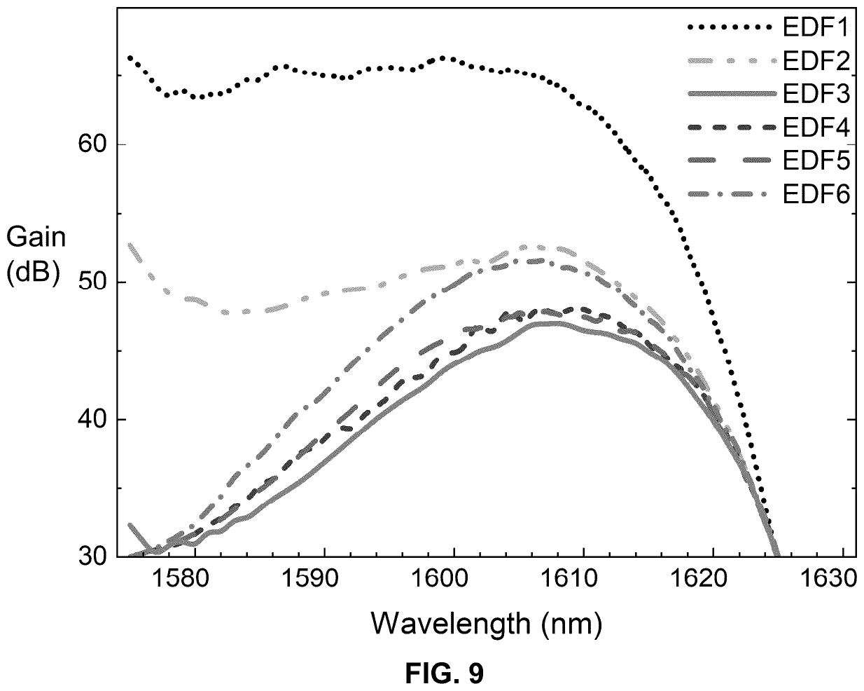

This gain ripple is, for example, plotted for EDF1 to EDF6 in FIG. 9. Examination of the graphs depicted in FIG. 9 shows that the absorption and emission spectra play a crucial role in determining the gain profile. Particularly noteworthy is the observation that EDF3 exhibits the smallest gain peak (located around 1610 nm). This lower gain variation indicates that EDF3 may require a gain-flattening filter (GFF) with a lower dynamic range and may achieve a higher pump-to-signal power conversion efficiency (PCE) compared to the other EDFs. Additionally, it thus appears that an optimal P/Al ratio is 2.5 and that deviating from this ratio results in an increased gain ripple, a deeper GFF, and subsequently, leads to a decrease in the EDFA performance. Taking into account the trade-off of the ESA and the potential formation of a star-like shape in the core, it can be inferred that an appropriate P/Al content favors the amplification process by flattening the α(λ) and g*(λ) spectra.

### Measurement of Erbium Ion Clustering

Employing a high concentration of Er ions in L-band EDFAs can be a practical strategy to decrease the EDF length in L-band amplifiers. This approach can lower background loss, mitigate non-linear effects, and lead to cost savings. However, highly doped EDFs are susceptible to Er ion clustering that can result in concentration quenching, especially pair-induced quenching (PIQ), and non-saturable absorption (NSA), potentially reducing the EDF power conversion efficiency. This is for example described in A. v. Kir'Yanov et al., “Er³⁺ concentration effects in commercial erbium-doped silica fibers fabricated through the MCVD and DND technologies,” IEEE J. Quantum Electron., vol. 49, no. 6, pp. 511-521, April 2013, the contents of which are incorporated herein by reference. Optimizing the Er concentration may quantify the level of PIQ in samples and determining its correlation with the material content.

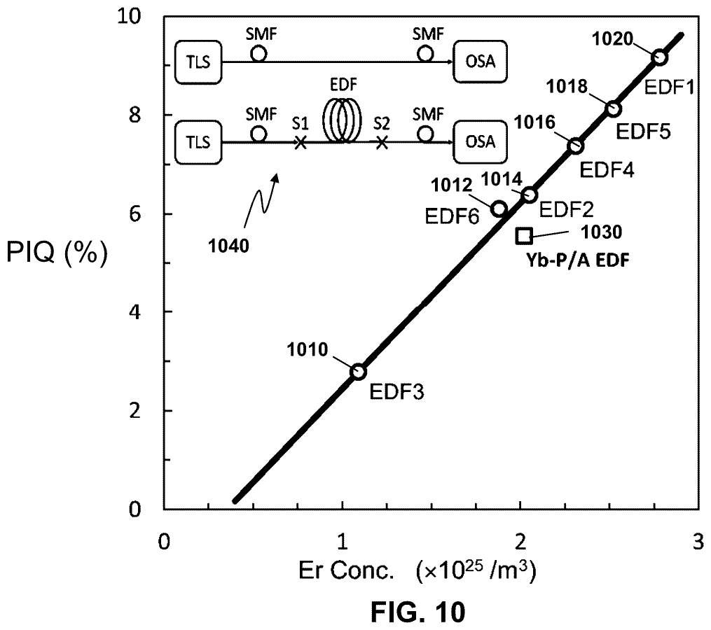

Referring to FIG. 10, this figure shows Er³⁺ pair percentage (PIQ) as a function of average Er³⁺ concentration in the preform core. Results for two co-dopants are presented, shown as circles 1010, 1012, 1014, 1016, 1018 and 1020 for Y—P/Al EDFs and square 1030 for the reference Yb—P/Al EDF sample. Inset 1040 illustrates the experimental setup for the two step NSA spectral measurements: without and with EDF.

In order to calculate the PIQ ratio, the method described S. Jalilpiran, supra, is used, with the experimental setup depicted in the inset 1040 of FIG. 10. To perform the measurement, a tunable laser source (TLS) was used with an output power range of −20 to 12 dBm, and an optical spectrum analyzer (OSA), with a 0.2 nm resolution, was used to measure the transmitted laser power.

The injected power was calibrated with a power meter and the setup was assembled with standard single-mode fibers (SMF).

In the first step (top schematic of inset 1040), the injected power was measured at S1. Next, the fiber sample was inserted using fusion splicing. The EDF lengths were chosen to ensure a consistent loss of 30 dB at the 1536 nm absorption peak. Splice losses were determined by measuring transmission at 1630 nm, where absorption is minimal, and were subsequently removed from the overall calculation.

Calibration and NSA measurements were carried out by sweeping the laser power from −15 to 12 dBm at wavelengths of 1530, 1535, 1540, 1545, and 1550 nm. Then, the fraction of Erbium ion pairs (κ) (or PIQ ratio) and the saturation coefficient (ζ) values were extracted using the model described in S. Jalilpiran, supra.

The obtained PIQ and ζ values are presented in Table 2. FIG. 10 plots the relationship between the PIQ ratio and the Er content for all the Y—P/A EDFs and the Yb—P/A EDF reference fiber. The PIQ value is important (up to 9.2%) at high Er concentrations, but it decreases considerably as the Er content decreases. With an uncertainty of ±1%, PIQ drops below 3% for EDF3. EDF1 to EDF5 exhibit a nearly linear correlation, while EDF6 deviates slightly from this linear trendline, exhibiting a slightly higher PIQ. Although this discrepancy is within the measurement uncertainty, it is also noted that EDF6 has the highest P/Al ratio associated with the lowest Al content, as indicated in Table 1. However, overall, the PIQ does not show a strong correlation with the P/Al ratio.

Meanwhile, EDF5, which has a 0.5% higher Al₂O₃ content compared to EDF6, aligns with the trendline. This observation, along with the comparison of EDF2 and EDF4 (having the same P₂O₅ content but different Al₂O₃), suggests that an Al₂O₃ content above 2 Mol. % does not lead to a significant further decrease in the PIQ ratio.

The same conclusion applies to the P₂O₅ content greater than 6 Mol. % and generally in the range of 6.3 to 9.1 Mol. % that does not appear to have a noticeable impact on the PIQ. Based on these findings, in order to keep the fraction of Er ion pairs below 3%, the Er concentration may be maintained at or below 1.2×10²⁵ m⁻³ when Y is used as the de-clustering agent.

A comparison between the PIQ of EDF6 and the Yb—P/Al EDF sample indicated that replacing Y with Yb does not result in a significant increase in PIQ. The difference between the two was only 0.5%, which is lower than the measurement uncertainty. Consequently, Y appears to be equally proficient as Yb in diminishing PIQ values. For these samples, a ratio of ˜12 between Y and Er concentration was used. In some embodiments, optimizing this ratio may result in further PIQ reduction.

Ultimately, Y demonstrates a level of effectiveness in mitigating PIQ values comparable to that of Yb, a widely recognized de-clustering agent.

### EDFA Characterization

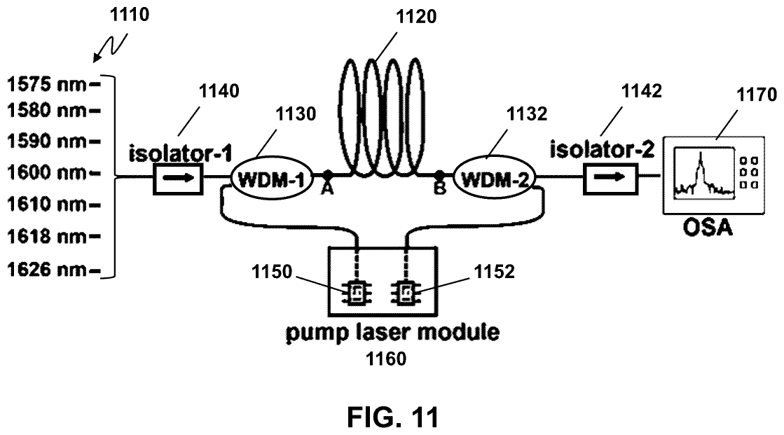

FIG. 11 depicts one example of an experimental setup utilized for measuring the EDF gain and NF under large signal excitation. The example of FIG. 11 uses a total input power of 1.3 dBm.

The input signal source 1110 consists of seven fixed channels spaced between 1575 nm to 1626 nm. The test fiber 1120 is placed between two 980/L-band wavelength division multiplexers (WDMs) 1130 and 1132, and two isolators 1140 and 1142.

Two 978 nm laser diodes 1150 and 1152, each with a power of 700 mW, are used for the bidirectional pumping of the fiber, shown as pump laser module 1160. The input signals are calibrated to the input port of the EDF (point A) to remove the impact of passive devices.

To record data, an optical spectrum analyzer (OSA) 1170 with a 0.1-nm resolution, was used. The splice losses were estimated and calibrated out of the final measured internal gain and NF. To ensure a fair comparison between the fibers, the optimal length for each EDF was chosen so the one that resulted in the lowest gain ripple within the 1575 nm to 1626 nm range was used.

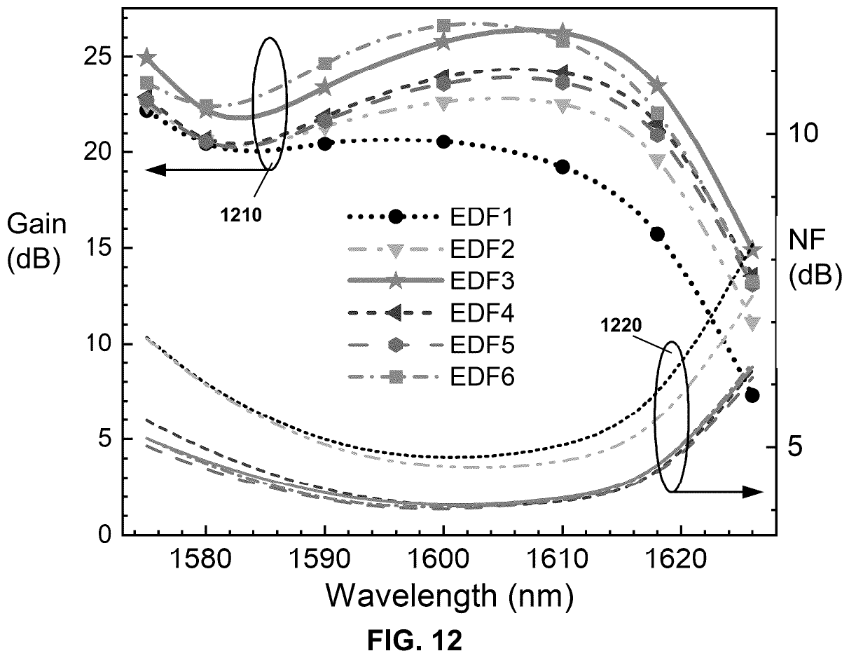

Reference is now made to FIG. 12, which shows the gain 1210 and NF 1220 for EDF1 to EDF6, with their respective optimized lengths of 25, 32, 49, 27, 22, and 36 m. Minimum gain and maximum NF are found at the longest wavelength (1626 nm) and are listed in Table 2 along with the gain ripple. Table 2 also highlights the variations in PIQ ratio among the fiber samples.

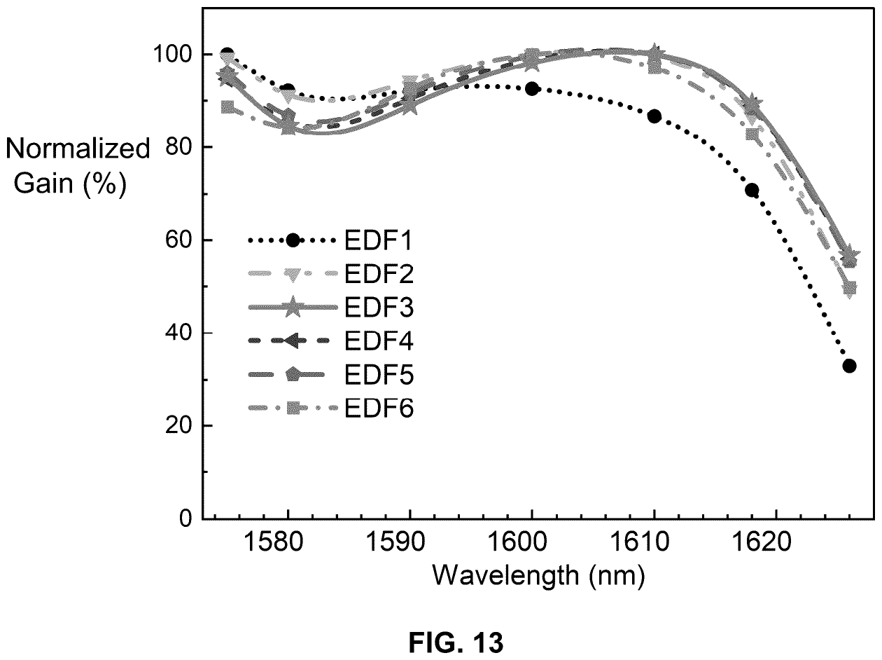

To assess the isolated impact of the P/Al ratio on gain bandwidth while eliminating the influence of PIQ, gain shapes that are normalized with respect to the gain value at 1575 nm may be used, as shown in FIG. 13.

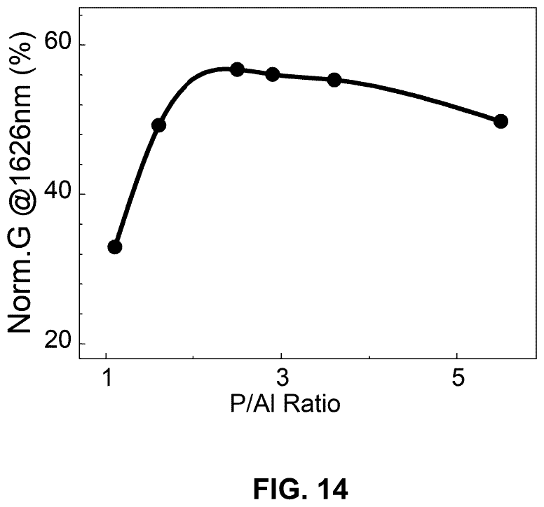

Furthermore, FIG. 14 shows the normalized gain at 1626 nm vs P/Al ratio, providing a method to evaluate the potential for extending the gain bandwidth of the fibers. Notably, EDF3 stands out with the highest absolute and normalized gain at 1626 nm, resulting in the lowest gain ripple. By comparing these values with those of EDF1 and EDF6, which represent the lowest and highest P/Al ratios, respectively, the significant impact of using this P/Al ratio becomes more evident. In addition, as this P/Al ratio is approached from either the maximum or minimum, the peak gain undergoes a redshift, shifting from 1600 to 1610 nm.

Based on the above, the performance of the phospho-alumino-silicate EDF can be improved through the incorporation of content of both P and Al as discussed. The improvement is achievable by effectively flattening the absorption and emission spectra within the L-band region. As detailed in Table 2, EDF3, with its P/Al ratio, exhibits a favorable outcome, increasing the lowest gain ripple (76%) when compared to EDF6 (101%), which represents the most P-rich fiber within the samples.

Such outcome remains consistent even though EDF6, compared to EDF3, causes a slight redshift in the ESA by approximately 0.7 nm and demonstrates a more well-defined core-clad interface, as evident in FIG. 3. This implies that EDF3 may require a GFF with a narrower dynamic range and demonstrates an increased PCE.

In addition, the P/Al ratio of EDF3 yielded results in terms of gain and NF, of 15 and 6.3 dB, respectively, at 1626 nm, even for larger signal inputs (1.3 dBm). These benefits are attributed to the flattening of the α(λ) and g*(λ) spectra.

Based on the above, a series of Y—P/Al EDFs were fabricated to extend the performance of optical amplifier to longer wavelengths in the L-band. Using standard MCVD and solution doping techniques, a P/Al mol % ratio between 1.1 and 5.5 was found. In some cases, the P/Al mol % ratio of between 2 and 4 was found to be effective. In one embodiment, a P/Al mol % around 2.5 was found, at an Er³⁺ concentration of 1.2×10²⁵/m³, and with 0.34 mol % of Y as de-clustering agent.

In a single-stage EDFA, a 20.5±5.7 dB internal gain was reported and a maximum of 6.3 dB noise figure over the extended L-band (up to 1626 nm) for 1.3 dBm input signal power. This demonstrates that P/Al is an effective combination of co-dopants to tune absorption and emission spectra of Er³⁺, with a beneficial impact on gain bandwidth.

The use of Yttrium as de-clustering agent brings the 980 nm pumping scheme as a viable, cost-effective option. Together, these results bring up the potential of the extended L-band wavelength range for future telecom amplifier applications.

The embodiments described herein are intended to be illustrative of the present compositions and methods and are not intended to limit the scope of the present invention. Various modifications and changes consistent with the description as a whole and which are readily apparent to the person of skill in the art are intended to be included. The appended claims should not be limited by the specific embodiments set forth in the examples, but should be given the broadest interpretation consistent with the description as a whole.

Further, as used herein, the term “about” or “approximately” as applied to a numerical value or range of values can mean within an acceptable error range for the particular value as determined by one of ordinary skill in the art, which will depend in part on how the value is measured or determined, i.e., the limitations of the measurement system. For example, “about” can mean within 1 or more than 1 standard deviation, per the practice in the art. Alternatively, “about” can mean a range of up to 20%, up to 10%, up to 5%, or up to 1% of a given value. Where particular values are described in the application and claims, unless otherwise stated the term “about” meaning within an acceptable error range for the particular value should be assumed. Numerical quantities given herein are approximate unless stated otherwise, meaning that the term “about” or “approximately” can be inferred when not expressly stated.

1. An optical glass fiber comprising an Erbium doped silicate, where the optical glass fiber comprises:
P₂O₅ of greater than 6 mol %; and
Al₂O₃ of between 1.5 and 6 mol %,
wherein a molar percent ratio of the P₂O₅ and the Al₂O₃ is between 2 and 4.

2. The optical glass fiber of claim 1, further comprising:
Y₂O₃ of between 0 and 1.1 mol %.

3. The optical glass fiber of claim 1, wherein an Erbium concentration in the Erbium doped silicate is between 1.2×10²⁵ per m³ and 2.6×10²⁵ per m³.

4. The optical glass fiber of claim 1, further comprising Yttrium, wherein an Erbium concentration in the Erbium doped silicate is at or below 1.2×10²⁵ m⁻³.

5. The optical glass fiber of claim 1, having the molar percent ratio of the P₂O₅ and the Al₂O₃ of about 2.5, an Erbium concentration of about 1.2×10²⁵/m³, and with about 0.34 mol % of Yttrium.

6. The optical glass fiber of claim 1, further comprising:
GeO₂ of between 0 and 6.1 mol %.

7. The use of the optical glass fiber of claim 1 in a Long Wavelength band amplifier.

8. The use of the optical glass fiber of claim 7, wherein the optical glass fiber is capable of amplification up to a wavelength of 1626 nm.

9. An optical glass fiber comprising an Erbium doped silicate, where the optical glass fiber comprises:
P₂O₅ of greater than 6 mol %; and
Al₂O₃ of between 1.5 and 6 mol %,
wherein a molar percent ratio of the P₂O₅ and the Al₂O₃ is between 1.1 and 5.5.

10. The optical glass fiber of claim 9, further comprising:
Y₂O₃ of between 0 and 1.1 mol %.

11. The optical glass fiber of claim 9, wherein an Erbium concentration in the Erbium doped silicate is between 1.2×10²⁵ per m³ and 2.6×10²⁵ per m³.

12. The optical glass fiber of claim 9, further comprising Yttrium, wherein an Erbium concentration in the Erbium doped silicate is at or below 1.2×10²⁵ m⁻³.

13. The optical glass fiber of claim 9, having the molar percent ratio of the P₂O₅ and the Al₂O₃ of about 2.5, an Erbium concentration of about 1.2×10²⁵/m³, and with about 0.34 mol % of Yttrium.

14. The optical glass fiber of claim 9, further comprising:
GeO₂ of between 0 and 6.1 mol %.
